(19) United States
(12) Patent Application Publication
(10) Pub. No.: US 2017/0080525 A1
(43) Pub. Date: Mar. 23, 2017

(54) METHOD FOR LASER-WELDING METAL PLATE LAMINATES AND METHOD FOR MANUFACTURING VEHICLE DOOR FRAME USING THE SAME

(71) Applicant: SHIROKI CORPORATION, Fujisawa-shi, Kanagawa (JP)

(72) Inventors: Atsuo NODA, Kanagawa (JP); Kenji SHIMIZU, Kanagawa (JP)

(73) Assignee: SHIROKI CORPORATION, Fujisawa-shi, Kanagawa (JP)

(21) Appl. No.: 15/126,458

(22) PCT Filed: Apr. 13, 2015
(86) PCT No.: PCT/JP2015/061371

§ 371 Date: Sep. 15, 2016

(30) Foreign Application Priority Data
Apr. 15, 2014 (JP) 2014-083599

(51) Int. Cl. B23K 26/244; B60J 5/04; B23K 26/28

(52) U.S. Cl. CPC B23K 26/244; B23K 26/28; B60J 5/0437; B60J 5/0426; B23K 2201/006

(57) ABSTRACT

A method for laser-welding metal plate laminates that is a laser welding method for laminating and bonding at least two metal plates, the method includes providing a protruding portion to one of the two metal plates; and causing the protruding portion to contact the other metal plate, and irradiating the protruding portion with laser beam so as to melt the protruding portion while applying force between the two metal plates to apply pressure to a contact portion of the protruding portion and the other metal plate.

### CROSS-REFERENCE TO RELATED APPLICATIONS

This application is national stage application of International Application No. PCT/JP2015/061371, filed Apr. 13, 2015, which designates the United States, incorporated herein by reference, and which claims the benefit of priority from Japanese Patent Application No. 2014-083599, filed Apr. 15, 2014, the entire contents of which are incorporated herein by reference.

### FIELD

The present invention relates to a method for laser-welding metal plate laminates. The present invention also relates to a method for manufacturing a vehicle door frame where metal plate laminates are bonded by welding.

### BACKGROUND

Patent Document 1 (Japanese Patent Application Laid-open No. 2013-199275) discloses a vehicle door. This vehicle door includes a metal door panel, a metal door sash fixed to the door panel, and a door glass supported slidably in a superior-inferior direction to the door panel. In manufacturing this kind of vehicle door, the configuration where a plurality of metal plates are laminated and are bonded by welding is often used. FIG. 7 illustrates a cross-sectional configuration of an insertion portion where a door sash is inserted into a door panel (cross-sectional face of the same position of that of line II-II in FIG. 1 in the detailed description of the invention) as one example. A door sash 50 includes a glass run holding portion 51 that has a glass run GR holding a door glass inserted therein, and a cylindrical portion 52 that protrudes from the glass run holding portion 51 to an indoor side. A lock bracket 53 is provided to the indoor side of the door sash 50, and a belt reinforcement 54 is also provided to an indoor side. The lock bracket 53 is fixed to a door panel as well as supports a door lock. The belt reinforcement 54 is an elongated member that extends in an anterior-posterior direction in the door panel, and FIG. 7 illustrates the vicinity of an end portion of the belt reinforcement 54.

Portions where the cylindrical portion 52 in the door sash 50, the lock bracket 53, and the belt reinforcement 54 are laminated are bonded by welding. FIG. 7 illustrates one example of a conventional bonding method, and illustrates that metal insert gas (MIG) welding is applied to the cylindrical portion 52 and the lock bracket 53 (which is illustrated as a numeral W11 in FIG. 7), and moreover, the belt reinforcement 54 is laminated with the lock bracket 53 and spot welding is applied to the laminated belt reinforcement 54 and lock bracket 53. The lock bracket 53 has a through hole 53a for MIG welding formed therein. FIG. 7 illustrates a state where spot welding is applied to the cylindrical portion 52 and the lock bracket 53 including the belt reinforcement 54 after MIG welding is provided between the cylindrical portion 52 and the lock bracket 53.

Currently, laser welding in addition to arc welding such as MIG welding and spot welding is often used as a method for bonding metal plate laminates. For example, in Patent Document 1, a shape of a door sash is determined by roll-molding, and laminated metal plates are fixed to each other by laser welding.

When a manufacturing method using the above-mentioned MIG welding and spot welding together is applied to a portion where a door sash is inserted illustrated in FIG. 7, the cylindrical portion 52 in the door sash 50 and the lock bracket 53 are bonded by MIG welding, and the belt reinforcement 54 is required to be spot-welded to a bonded body of the cylindrical portion 52 and the lock bracket 53, and these three members are unable to be welded integrally. By contrast, when three members of the cylindrical portion 52 in the door sash 50, the lock bracket 53, and the belt reinforcement 54 are laminated and are integrally laser-welded, workability is considerably improved as compared to the method using MIG welding and spot welding together.

When a plurality of metal plate laminates are laser-welded, laser beam needs to be emitted after parts to be welded are securely contacted. However, parts to be welded are unlikely to be properly contacted due to accuracy error of components. If laser-welding is performed in such a state, the welding is failed and each metal plate is likely to be separated. For example, differently from Patent Document 1 in which laser-welding is performed in a manufacturing process of a door sash single body, in the configuration of FIG. 7, individually manufactured three members (the door sash 50, the lock bracket 53, and the belt reinforcement 54) are bonded, and, even when an accuracy error of each component is within a tolerance range, variation in accuracy is accumulated and an extraordinary gap that is not negligible upon laser-welding may be generated. In other words, conventionally, it is difficult to laser-weld the parts.

A vehicle door is described as an example, but, when a plurality of metal plate laminates are laser-welded, the same kind of problem needs to be considered beyond the field of a vehicle door.

In view of the foregoing, an object of the present invention is to provide a laser welding method capable of easily and securely bonding a plurality of metal plate laminates, and a method for manufacturing a vehicle door frame using the laser welding method of metal plate laminates.

### SUMMARY

A laser-welding method for laminating and bonding at least two metal plates according to the present invention comprises providing a protruding portion to one of two metal plates, and causing the protruding portion to contact the other metal plate, and irradiating and melting the protruding portion with laser beam while applying force between the two metal plates to apply pressure to the contact portion of the protruding portion and the other metal plate.

The protruding portion may contact the other metal plate on a flat face.

When pressure is applied in the irradiating of laser beam, any position where force is applied to metal plates can be set, but as an example, an area other than the protruding portion in one metal plate including the protruding portion may be pressed.

The irradiating may include emitting the laser beam in a spiral trajectory.

The present invention can be applied to bonding of three or more metal plates. When the present invention is applied to three metal plates that are an intermediate metal plate and a pair of outer metal plates on both sides of the intermediate metal plate, a protruding portion may be provided to each of the outer metal plates, and laser beam may be emitted in a positional relation in which the protruding portions of the outer metal plates are opposite to each other with the intermediate metal plate interposed therebetween.

A tip of a protruding portion formed on a metal plate is preferably in a curved shape.

The method for laser-welding metal plate laminates according to the present invention can be applied to a variety of technical fields. For example, the laser welding method can be used as a means for bonding components forming a vehicle door frame. Specifically, it is effective to apply the laser welding method to a method for laminating and bonding a part of a door sash forming a window frame of a door, a part of a lock bracket supporting a door lock, and a part of a belt reinforcement arranged along a belt line of a door.

For example, a protruding portion can be provided to a door sash and a belt reinforcement. When a protruding portion is provided to a door sash, the protruding portion may be, out of a cylindrical portion positioned on an indoor side, a design portion positioned on an outdoor side, and a connection portion connecting the cylindrical portion to the design portion, provided to the cylindrical portion.

According to the present invention, a plurality of metal plates to be welded can be easily and securely bonded by causing the metal plates to contact a protruding portion, and irradiating and melting the protruding portion with laser beam while pressure is applied.

### BRIEF DESCRIPTION OF DRAWINGS

FIG. 1 is a side view illustrating a door for a front seat of a vehicle that is manufactured by applying a laser welding method according to the present invention viewed from an indoor side;

FIG. 2 is a cross-sectional view along line II-II of FIG. 1;

FIG. 3 is a cross-sectional view illustrating a process for laser-welding a door sash, a lock bracket, and a belt reinforcement represented on a cross-sectional face of FIG. 2;

FIG. 4 is a cross-sectional view illustrating a state where the same laser welding is completed;

FIG. 5 is a cross-sectional view illustrating a first modification of laser welding;

FIG. 6 is a cross-sectional view illustrating a second modification of laser welding; and

FIG. 7 is a cross-sectional view illustrating a state where a door sash, a lock bracket, and a belt reinforcement disposed at the same cross-sectional position as that of FIG. 2 are welded using a conventional method.

### DETAILED DESCRIPTION

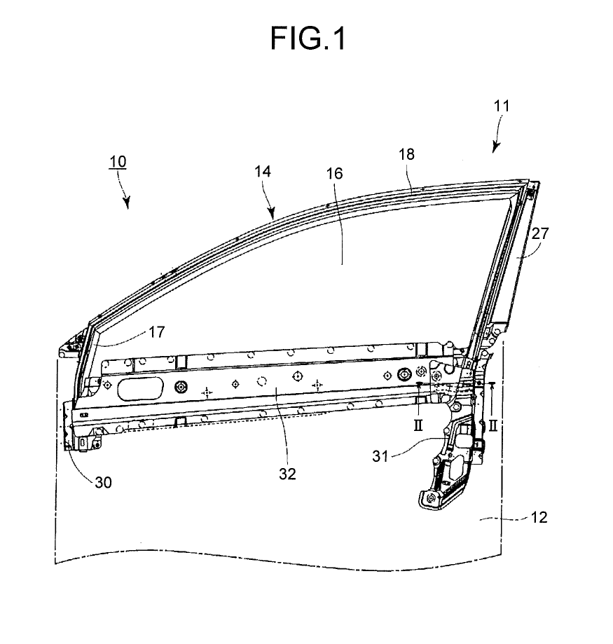

An exemplary embodiment of the present invention will now be described with reference to the accompany drawings. In this embodiment, the present invention is applied to bonding of metal plates forming a door frame of a door 10 for a front seat on the right side in a vehicle illustrated in FIG. 1 (hereinafter, referred to as the door 10). First, a main part structure of a door is described. Hereinafter, a side facing an window opening 16 in a door sash 14 of the door 10 is referred to as an “inner peripheral side”, and a side facing a vehicle body opening on a side opposite to the inner peripheral side is referred to as an “outer peripheral side”. Expression of directions such as a front portion, a rear portion, an upper portion, a lower portion, an indoor side, and an outdoor side means directions using a vehicle body to which the door 10 is attached (A left right direction means a direction viewed from a driver's seat to a front portion).

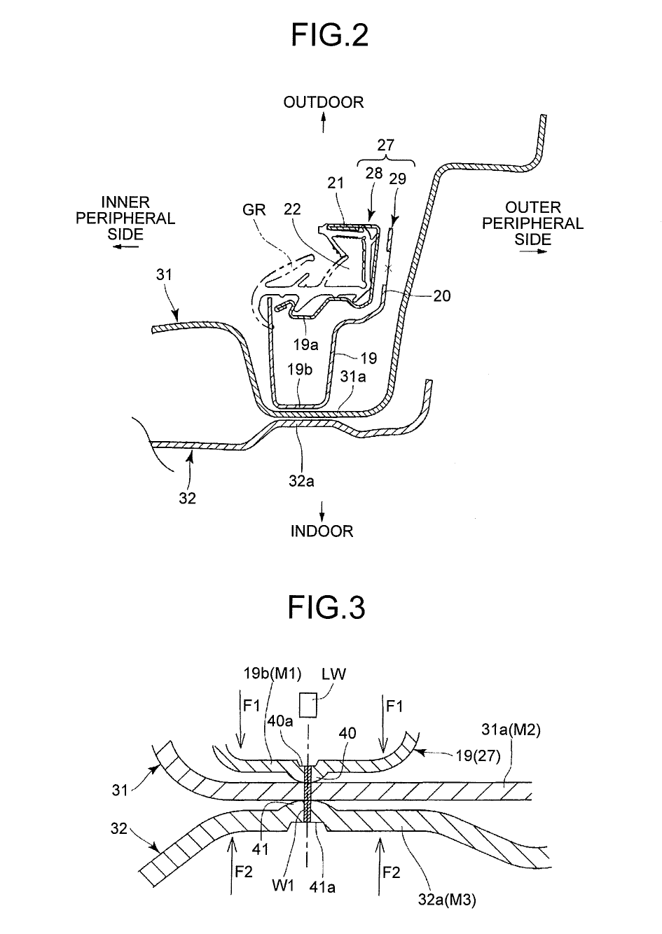

The door 10 illustrated in FIG. 1 includes a door frame assembly 11 indicated by a solid line and a metal door panel 12 in an outline shape indicated by a virtual line. The door frame assembly 11 is formed of a metal door sash 14 formed in a frame shape on the upper portion of the door panel 12, a hinge bracket 30 and a lock bracket 31 connected to the lower portion of the door sash 14, and an elongated belt reinforcement 32 connecting the hinge bracket 30 to the lock bracket 31 and extending in an anterior-posterior direction. In a window opening 16 surrounded by an upper edge portion of the door panel 12 (upper edge portion of the belt reinforcement 32) and an inner edge portion of the door sash 14, a door glass, which is not illustrated, is lifted and lowered. An inner peripheral portion of the door sash 14 facing the window opening 16 is provided with a glass run GR (FIG. 2) made of an elastic material, and an edge portion of a door glass is held by the glass run GR. By contrast, an outer peripheral portion of the door sash 14 is provided with a weather strip (not illustrated) made of an elastic material. The door sash 14 includes a front sash 17 forming a front edge portion of the door sash 14, an upper sash 18 forming a door upper edge portion, and a standing pillar sash 27 extending from the rear portion of the door panel 12 to the upper portion. The upper end portion of the front sash 17 and the front end portion of the upper sash 18 are welded, and moreover, the rear end portion of the upper sash 18 and the upper end portion of the standing pillar sash 27 are welded at a door corner portion. When the door 10 is closed with respect to a vehicle body, which is not illustrated, the upper sash 18 is positioned along a door opening of a roof panel in the vehicle body, and the weather strip contacts the inner peripheral face of the door opening while being elastically deformed.

The door panel 12 includes an inner panel positioned on an indoor side and an outer panel positioned on an outdoor side, a part of the lower portion of the front sash 17 and the standing pillar sash 27 is inserted between the inner panel and the outer panel. The hinge bracket 30 is fixed to a part where the front sash 17 is inserted into the door panel 12, the lock bracket 31 is fixed to a part where the standing pillar sash 27 is inserted into the door panel 12, and the front and rear end parts of the belt reinforcement 32 are fixed to the hinge bracket 30 and the lock bracket 31. The belt reinforcement 32 is formed as an assembly that combines a plurality of members, and a sub-bracket formed independently of a main body long in the anterior-posterior direction in the belt reinforcement 32 is fixed to the lock bracket 31.

As illustrated in FIG. 2, the standing pillar sash 27 is formed by combining an outer member 28 and an inner member 29. The outer member 28 is formed as an elongated member having an illustrated cross-sectional shape by roll-molding or press-molding a plate-like ferrous material (for example, steel use stainless (SUS)) while the ferrous material is transferred in a certain direction by a transfer device, which is not illustrated. The inner member 29 is formed as an elongated member having an illustrated cross-sectional shape by press-molding the same material as that of the outer member 28. The standing pillar sash 27 includes a cylindrical portion 19 positioned on an indoor side and formed in a closed cross-sectional shape, a connection portion 20 extending from the cylindrical portion 19 to the outdoor side, and a design portion 21 positioned on an outdoor side. Only the design portion 21 on the outer member 28 side is illustrated at a cross-sectional position in FIG. 2, but in an appearance part that protrudes from the door panel 12 to the upper portion in the standing pillar sash 27, the design portion 21 wider toward the outer peripheral side is also formed on the inner member 29. As illustrated in FIG. 2, the glass run GR is inserted into a glass run holding portion 22 surrounded by an outdoor side portion 19a of the cylindrical portion 19, the connection portion 20, and the design portion 21.

The cylindrical portion 19 in the standing pillar sash 27 includes an indoor side portion 19b positioned on an indoor side opposite to the outdoor side portion 19a. A bonding portion 31a of the lock bracket 31 is laminated with an indoor side face of the indoor side portion 19b, and moreover, a bonding portion 32a of the belt reinforcement 32 is laminated with an indoor side face of the bonding portion 31a. As illustrated in FIG. 2, parts where the indoor side portion 19b, the bonding portion 31a, and the bonding portion 32a are laminated are formed into flat plate shapes that are substantially parallel to each other except for protrusions (protruding portions) 40 and 41, which will be described later, laser-welding is performed while the indoor side portion 19b, the bonding portion 31a, and the bonding portion 32a are laminated, and the standing pillar sash 27, the lock bracket 31, and the belt reinforcement 32 are integrally bonded. A process of bonding is described.

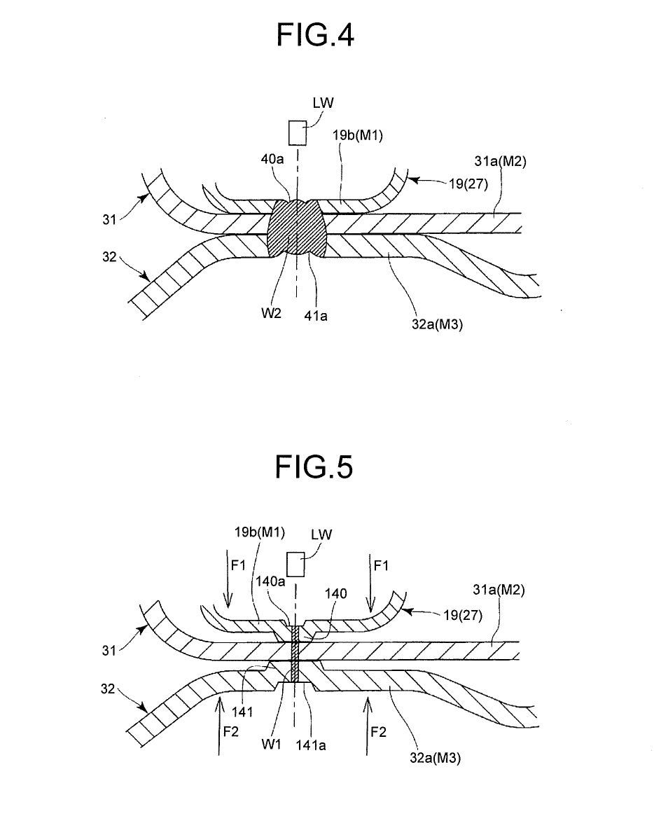

FIGS. 3 and 4 illustrate a process of laser-welding the indoor side portion 19b, the bonding portion 31a, and the bonding portion 32a. For convenience, in the following description, the indoor side portion 19b, the bonding portion 31a, and the bonding portion 32a are referred to as an outer metal plate M1, an intermediate metal plate M2, and an outer metal plate M3, respectively. The term “outer” means being positioned on both sides with the intermediate metal plate M2 interposed therebetween, and is different in meaning from an outdoor side in the door 10. The mutually opposed faces of the metal plates M1, M2 and M3 are formed to be substantially parallel to each other. As illustrated in FIG. 3, the outer metal plate M1 is provided with the protruding portion 40 that protrudes on a side (indoor side) close to the intermediate metal plate M2, and the outer metal plate M3 is provided with the protruding portion 41 that protrudes on a side (outdoor side) close to the intermediate metal plate M2. The protruding portions 40 and 41 are formed by protruded shape forming that pushes up the protruding portions 40 and 41 from a face side opposite to the intermediate metal plate M2 and an opposite rear face side so as to be protruded, and dents 40a and 41a upon protruded shape forming are present on the rear face side of the protruding portions 40 and 41. The tip of the protruding portions 40 and 41 is formed into a curved cross-sectional shape as illustrated in FIG. 3.

As illustrated in FIG. 3, the outer metal plate M1, the intermediate metal plate M2, and the outer metal plate M3 are set in a relation where the protruding portions 40 and 41 are opposite to each other with the intermediate metal plate M2 interposed therebetween (a contact point between the protruding portion 40 and the intermediate metal plate M2 and a contact point between the protruding portion 41 and the intermediate metal plate M2 are positioned on the same straight line). Subsequently, while a pressurizing device, which is not illustrated, pressurizes the outer metal plate M1 towards the intermediate metal plate M2 (arrow F1 in FIG. 3), and pressurizes the outer metal plate M3 towards the intermediate metal plate M2 (arrow F2 in FIG. 3) (in other words, applies pressure in a direction where the protrusion height of the protrusions 40 and 41 is reduced), a laser beam emitting unit LW (torch) arranged behind the protruding portion 40 emits laser beam, and the protruding portions 40 and 41 are irradiated with this laser beam and are laser-welded. Pressure is applied to an ambient area except for the protrusions 40 and 41 in the outer metal plate M1 and the outer metal plate M3. Performing laser-welding as well as applying pressure causes the protrusions 40 and 41 to be melted and not to be formed in a protruding shape as illustrated in FIG. 4, and causes the outer metal plate M1 and the outer metal plate M3 to contact the intermediate metal plate M2 on the faces or to be in a state close to the face contact. Areas W1 and W2 illustrated in FIGS. 3 and 4 illustrate parts melted by laser beam. The laser beam emitting unit LW can adjust an emitting direction of laser beam with a swinging operation. The center portion of the protrusions 40 and 41 is melted as the initial melted portion W1 in FIG. 3, and moreover, the laser beam emitting unit LW performs swinging operation and spiral welding that spirally expands a melted area is performed so as to form the final melted portion W2 in FIG. 4 and implement firm fixation.

In this manner, the outer metal plate M1 and the outer metal plate M3 are respectively provided with the protrusions 40 and 41 that determine contact positions with respects to the intermediate metal plate M2, and performing laser-welding using the protrusions 40 and 41 as targets as well as applying pressure causes the mutual contacts points to be securely welded so as to prevent welding failure even when there is a small dimensional error among the outer metal plate M1, the intermediate metal plate M2, and the outer metal plate M3. Work can be completed in a short time and productivity is improved because the three sheets of the outer metal plate M1, the intermediate metal plate M2, and the outer metal plate M3 are integrally bonded by laser welding one time.

The laser beam emitting unit LW is disposed behind the protruding portion 40 (dent 40a side) in FIG. 3, but the laser beam emitting unit LW may be disposed behind the protruding portion 41 (dent 41a side). In any case, three sheets of the outer metal plate M1, the intermediate metal plate M2, and the outer metal plate M3 can be securely penetrated and welded by appropriately setting output of laser beam.

In the embodiment, the pressure F1 and F2 in the opposite directions to each other are individually applied to the outer metal plate M1 and the outer metal plate M3, but the same effect can be obtained even when pressure (pressure in a direction close to the intermediate metal plate M2) is, after any one of the outer metal plate M1 and the outer metal plate M3 is supported by a fixed object, applied to only the other and laser-welding is performed.

In a first modification illustrated in FIG. 5, a contact face (tip face) of a protrusion 140 provided to the outer metal plate M1 and a contact face (tip face) of a protrusion 141 provided to the outer metal plate M3 are different in shape. The protrusions 40 and 41 in the embodiment as described above have shapes for point contact with the intermediate metal plate M2 (line contact when welding is applied to a line-shaped area). By contrast, the protrusions 140 and 141 have flat contact faces for face contact with the intermediate metal plate M2. Along with a change in the contact face shape, dents 140a and 141a formed on the rear face side of the protrusions 140 and 141 have shapes different from those in the above-mentioned embodiment (FIG. 5 illustrates a specific cross-sectional position and does not illustrate the flat shape of the dents 140a and 141a). The laser welding method in the first modification is in common with the embodiment as described above, and a bonding state becomes the same as that in FIG. 4 by applying pressure to the vicinity of the protrusions 140 and 141 and performing laser-welding.

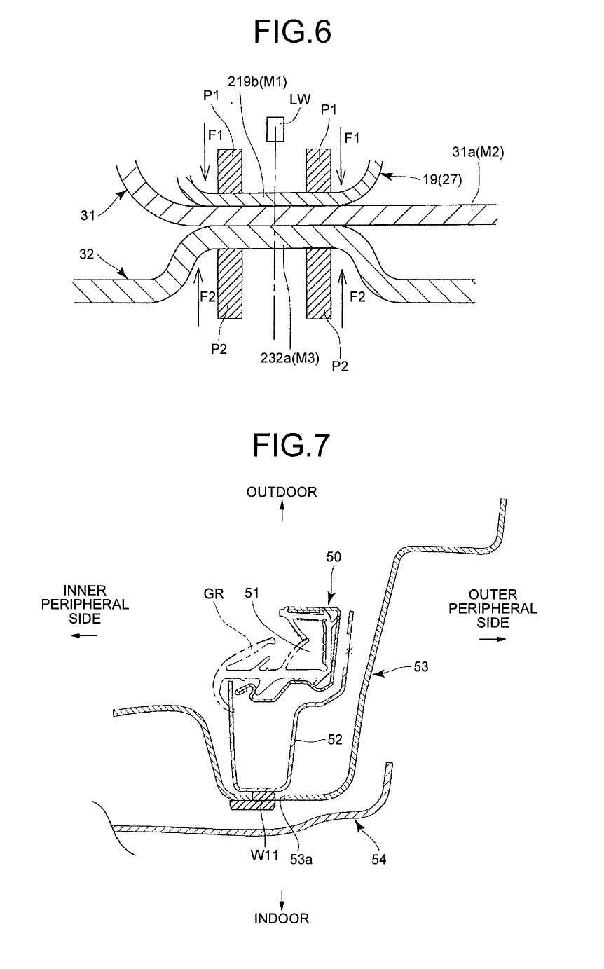

Differently from the above-mentioned configuration where pressure is applied to the vicinity of the protrusions 40 (140) and 41 (141) upon laser-welding, in a second modification illustrated in FIG. 6, laser welding is performed while pressure is applied to a protruding portion on the outer metal plate M1 contacting the intermediate metal plate M2 and a protruding portion on the outer metal plate M3 contacting the intermediate metal plate M2. In this second modification, the protruding portion on the outer metal plate M1 is a whole indoor side portion 219b (which is a part corresponding to the indoor side portion 19b illustrated in FIG. 2, but has a different numeral for convenience) in the cylindrical portion 19 of the standing pillar sash 27, and the indoor side portion 219b can be pressurized toward a side close to the intermediate metal plate M2 by a pressing unit P1 forming the pressurizing device. The protruding portion on the outer metal plate M3 is a whole bonding portion 232a (which is a part corresponding to the bonding portion 32a illustrated in FIG. 2, but has a different numeral for convenience) in the belt reinforcement 32, and the bonding portion 232a can be pressurized toward a side close to the intermediate metal plate M2 by a pressing unit P2 forming the pressurizing device. While the outer metal plate M1 (indoor side portion 219b) and the outer metal plate M3 (bonding portion 232a) are each pressurized toward the intermediate metal plate M2 by the pressing units P1 and P2, welding is performed by laser beam which the laser beam emitting unit LW emits. A state after welding is almost the same as that in FIG. 4, but, in the embodiment of FIG. 4, trace of the dents 40a and 41a is slightly remained. By contrast, in the modification of FIG. 6, trace such as the dents 40a and 41a is not remained because the protrusions 40 (140) and 41 (141) are not formed.

As described above, the present invention is described based on the illustrated embodiment, but the present invention is not limited to the illustrated embodiment, and reformation and modification can be made without departing from the gist of the invention. For example, three sheets of metal plate laminates are bonded in the illustrated embodiment, but the present invention can be applied to a case where two or more sheets of metal plates are bonded. When the present invention is applied to bonding of two metal plates, laser-welding may be performed with the configuration where the outer metal plate M1 or the outer metal plate M3 in the illustrated embodiment is omitted. In other words, when a protruding portion is formed on one of two metal plates and contacts the other metal plate, laser-welding may be performed by irradiating the protruding portion with laser beam while pressure is applied to this contact portion.

When two sheets of metal plates are defined as a constituent unit, pressure can be applied to a contact portion in any aspects out of an aspect where pressure is applied to a metal plate including a protruding portion, an aspect where pressure is applied to a metal plate contacting the protruding portion, and an aspect where pressure is applied to two sheets of metal plates. For example, when two sheets of metal plates are defined as the outer metal plate M1 and the intermediate metal plate M2 in the illustrated embodiment, the pressure F1 illustrated in FIGS. 3, 5, and 6 may be applied to the outer metal plate M1, the pressure F2 illustrated in FIGS. 3, 5, and 6 may be applied to the intermediate metal plate M2, and pressure may be applied to both metal plates. When only the outer metal plate M1 is pressurized, the intermediate metal plate M2 is fixed and supported, and when only the intermediate metal plate M2 is pressurized, the outer metal plate M1 is fixed and supported. When pressure is applied to a metal plate including a protruding portion, an area other than the protruding portions (protrusions 40 and 41) in a metal plate may be pressurized as illustrated in FIGS. 3 and 5, and protruding portions (indoor side portion 219b, bonding portion 232a) are pressurized as illustrated in FIG. 6.

The illustrated embodiment is applied to bonding of metal plates forming a door frame assembly of a vehicle, but an application field of the present invention is not limited to manufacturing of a vehicle door frame, and the present invention is widely applied to the configuration where laminated metal plates are bonded by welding.

As described above, in a laser welding method in the present invention, a protruding portion provided to one of the two laminated metal plates contacts the other metal plate, and the protruding portion is irradiated with laser beam and is melted while force is applied between the two metal plates to apply pressure to the contact portion. This enables metal plates to be easily and securely bonded. Applying this laser welding method to manufacturing of a vehicle door frame can improve productivity and quality of a door frame.

1. A method for laser-welding metal plate laminates that is a laser welding method for laminating and bonding at least two metal plates, the method comprising:
providing a protruding portion to one of the two metal plates; and
causing the protruding portion to contact the other metal plate, and irradiating the protruding portion with laser beam so as to melt the protruding portion while applying force between the two metal plates to apply pressure to a contact portion of the protruding portion and the other metal plate.

2. The method for laser-welding metal plate laminates according to claim 1, wherein the protruding portion contacts the other metal plate on a flat face.

3. The method for laser-welding metal plate laminates according to claim 1, wherein, the irradiating the protruding portion with the laser includes applying, pressure is applied to an area other than the protruding portion in one of the metal plates.

4. The method for laser-welding metal plate laminates according to claim 1, wherein, the irradiating includes emitting the laser beam in a spiral trajectory.

5. The method for laser-welding metal plate laminates according to claim 1, wherein an intermediate metal plate, and a pair of outer metal plates on both sides of the intermediate metal plate are laminated, the protruding portion is provided to each of the outer metal plates, and
the irradiating the protruding portion with the laser beam is performed in a positional relation in which the protruding portions of the outer metal plates are opposite to each other with the intermediate metal plate interposed therebetween.

6. The method for laser-welding metal plate laminates according to claim 1, wherein a tip of the protruding portion is formed in a curved shape.

7. A method for manufacturing a vehicle door frame using the method for laser-welding metal plate laminates according to claim 1, wherein the metal plate laminates are a part of components forming a vehicle door frame.

8. The method for manufacturing a vehicle door frame using the method for laser-welding metal plate laminates according to claim 7, wherein the metal plate laminates are a part of a door sash forming a window frame of a door, a part of a lock bracket supporting a door lock, and a part of a belt reinforcement arranged along a belt line of a door.

9. The method for manufacturing a vehicle door frame using the method for laser-welding metal plate laminates according to claim 8, wherein the door sash includes a cylindrical portion positioned on an indoor side, a design portion positioned on an outdoor side, and a connection portion connecting the cylindrical portion to the design portion, and the cylindrical portion is provided with the protruding portion.

10. The method for manufacturing a vehicle door frame using the method for laser-welding metal plate laminates according to claim 8, wherein the belt reinforcement is provided with the protruding portion.
